(19) United States
(12) Patent Application Publication
(10) Pub. No.: US 2024/0399654 A1
(43) Pub. Date: Dec. 5, 2024

(54) Method for Additive Manufacturing of a Three-Dimensional Object

(71) Applicant: Bayerische Motoren Werke Aktiengesellschaft, Muenchen (DE)

(72) Inventors: Joel BACHMANN, Muenchen (DE); Martin FRIEDRICH, Heroldsberg (DE); Lukas KNORR, Muenchen (DE); Philip OBST, Kirchheim bei Muenchen (DE); Lasse REUSCH, Aachen (DE)

(21) Appl. No.: 18/697,664

(22) PCT Filed: Nov. 4, 2022
(86) PCT No.: PCT/EP2022/080801

§ 371 Date: Apr. 1, 2024

(30) Foreign Application Priority Data
Nov. 25, 2021 (DE) 10 2021 130 981.6

(51) Int. Cl. B29C 64/124; B33Y 10/00; B33Y 80/00

(52) U.S. Cl. CPC B29C 64/124; B33Y 10/00; B33Y 80/00

(57) ABSTRACT

A method for additive manufacturing of an item includes a first solidification step and a second solidification step. In the first solidification step, at least one structure section having a first degree of solidification is formed. The at least one structure section delimits at least one interior accommodating a liquid construction material. The item is a three-dimensional object having a resin-based construction material which is liquid in a base state and is solidifiable. In the second solidification step a deformation section is formed. The deformation section has a second degree of solidification that is different from the first degree of solidification. The deformation section is formed from the liquid construction material accommodated in the interior.

### BACKGROUND AND SUMMARY

The disclosure relates to a method for additive manufacturing of a three-dimensional object from a resin-based construction material that is liquid in a base state and can be solidified.

Methods for additive manufacturing of three-dimensional objects are known in principle from the prior art. Among others, methods are known which construct the three-dimensional object from a resin-based construction material that is liquid in its base state. The construction material is typically changed by a corresponding introduction of energy, in particular by means of radiation, so that it crosslinks or solidifies. At the end of the manufacturing process, the object can be taken out of the non-solidified construction material or non-solidified construction material can be removed from cavities in the object, so that ultimately the solidified object can be taken out of the non-solidified liquid construction material remaining in its base state or residues of non-solidified construction material can be removed. Such objects typically comprise the same strength over the entire object. If the object is to have different strengths or other mechanical properties, this is typically achieved via the geometry or via the use of different construction materials.

Furthermore, it is known to introduce different inputs of energy during the solidification, for example, using different intensities or exposure times in order to solidify the corresponding sections of the object differently. In other words, it is possible to make various sections more solid or more brittle by selecting the exposure parameters differently. The selection or setting of the mechanical properties, in particular the strength, is only possible to a limited extent, however, since ultimately solidification and crosslinking of the resin-based construction material always takes place in the solidification step. Forming different areas of the object which have fundamentally different mechanical properties is typically not possible in the same manufacturing process in stereolithography methods.

The disclosure is based on the object of specifying a method improved in relation thereto for additive manufacturing of a three-dimensional object in which in particular different sections can be formed having different mechanical properties.

The object is achieved by the inventive method according this disclosure. The disclosure also relates to possible embodiments.

As described, the disclosure relates to a method for additive manufacturing of a three-dimensional object from a resin-based construction material that is liquid in a base state and can be solidified. The method is carried out in particular in a construction material reservoir, in particular in a construction space delimited by a trough, in which liquid construction material is selectively solidified. The disclosure is based on the finding that in a first solidification step, at least one structure section having a first degree of solidification is formed, which delimits at least one interior accommodating liquid construction material, and in a second solidification step, a deformation section having a second degree of solidification different from the first degree of solidification is formed from the liquid construction material accommodated in the interior.

In other words, the disclosure proposes carrying out two differentiated solidification steps, wherein a structure section is formed in a first solidification step and a deformation section is formed in a second solidification step. The structure section delimits an interior in which liquid construction material is accommodated. The liquid construction material can also be solidified in the second solidification step, the structure section and the deformation section having different degrees of solidification, however. In other words, the created mechanical properties of the solidified construction material can fundamentally change in structure section and deformation section. The difference in the mechanical properties or the two degrees of solidification in particular goes beyond what is possible due to different exposure intensities or exposure times.

As described, the structure section forms a receptacle, in particular an envelope, for the at least one interior, in which, after completion of the first solidification step, the resin-based construction material is present in its base state and is therefore still liquid. Instead of carrying out a single solidification step, as is typical in the prior art, in which all sections of the object are brought to the desired degree of solidification and then the construction material which is not solidified is removed from the manufactured object, after completion of the first solidification step, non-solidified construction material is deliberately left as a component of the object in the at least one interior. In the second solidification step, which can follow the first solidification step, the liquid construction material in the interior is solidified in order to form the deformation section of the object. In other words, the enclosed construction material is not removed later, but rather deliberately used to form a deformation section differing from the structure section. The solidification steps are in particular different from one another with respect to time and with respect to the solidification mechanism, for example, a solidification by means of introduction of radiation and a solidification by introduction of heat.

This offers the possibility in particular of forming the structure section and the deformation section, which, as described, have different mechanical properties, from a uniform material and in a materially bonded manner. It is therefore not necessary to use different construction materials for different areas or different sections or different functions of the object. Instead, the additive manufacturing process can be carried out from a single construction material or using a single construction material. The structure section thus forms a hard area or a “hard shell”, in which the construction material which is liquid after completion of the first solidification step is present and a deformation section which is softer than or not as hard as the structure section is formed after completion of the second solidification step. In principle, different properties or different material states can be achieved when carrying out the solidification steps. In the first solidification step, for example, a thermoset can be created from the construction material. A thermoset or an elastomer can be created from the resin-based construction material during the manufacturing of the deformation section.

The terms “structure section” and “deformation section” can be selected or changed as desired. The “structure section” has a higher strength than the “deformation section” or the construction material solidified as the structure section can be stronger than the construction material in the deformation section. The structure section can therefore limit movement or deformation of the object. The deformation section can accordingly be deformed more easily, so that the deformation section can be made more elastic than the structure section, for example, to permit a defined movement of the component or object. Various options are thus possible with respect to deformations, force transmissions, and the like, which are described hereinafter.

As described above, the two solidification steps can be carried out independently of one another, in particular with respect to time and device, and can be based on different mechanisms. It is to be noted in this case that the first solidification step has to be carried out before the second solidification step in order to delimit the interior in which the liquid construction material is accommodated, which is solidified in the second solidification step as the deformation section.

According to one embodiment of the method, it can be provided that the first solidification step is carried out by exposure of construction material and/or the second solidification step is carried out by temperature control of construction material. In other words, according to this embodiment the first solidification step can be carried out by the construction material being exposed. The exposure of construction material can ultimately comprise an introduction of energy from radiation, for example, a focused exposure by means of an energy beam or a planar exposure using a mask or a DLP process or a large number of single individually controllable radiation sources. The wavelength of the light used or the radiation used is determined by the properties of the construction material. For example, radiation sources from the IR spectrum or the UV spectrum can be used. In contrast, the second solidification step can be carried out by temperature control of construction material. In this case, the construction material can have a composition such that it solidifies upon exceeding a specific solidification temperature. As described, the selection of the resin-based construction material can in principle be selected arbitrarily. The construction material has active or reactive groups which cause solidification or crosslinking of the construction material due to suitable introduction of energy.

According to a further embodiment of the method, it can be provided that a formation of at least two areas of the object for defining the mechanical properties of the object, in particular a structure defining the mechanism, is divided into the first solidification step and the second solidification step. The described structure can therefore have at least one first area or at least one first section and at least one second area or at least one second section, which interact with one another to define the mechanical properties. For example, the two areas can be supported on one another or become supported on one another under force action, for example, interlock.

Upon application of an external force to the object, which deforms the object, for example, compresses, stretches, lengthens, or deforms it, a defined deformation can be permitted by the at least one of the at least two areas, according to which two solid areas press against one another upon reaching a specific deformation limit. In this case, for example, two structure areas of the structure section can come into contact, which do not permit a further deformation, or only permit a further deformation to a limited extent, due to their increased strength. The two structure areas of the structure section can be coupled to one another by a deformation area of the deformation section or can be movably mounted therein by force action. The structure which defines the mechanical properties can comprise, for example, the two structure areas of the structure section and the at least one deformation area of the deformation section. The structure can have an arbitrary number of areas which can be assigned as desired to the structure section or the deformation section or form a component thereof.

Furthermore, it can be provided that at least one force transmission path arranged in the interior is formed, which force transmission path has a defined deformation area and a defined support area, in particular a structure section having the first degree of solidification within a deformation section having the second degree of solidification. The force transmission path thus allows the transmission of a force along a path which extends through the object. The object can be in a base state here, for example, in which no force acts on the object. In the base state, for example, the two support areas or support sections do not touch directly, but rather are coupled with one another via the deformation area or the at least one deformation section. If a force is produced along the force transmission path from the described base state, the deformation section can initially be deformed, which can be deformed more easily due to the second degree of solidification, which is below the first degree of solidification. The deformation can thus take place via the defined deformation area.

If the defined deformation area is exceeded, at least two support areas or structure areas of the structure section can come into contact. Due to the contact of the two support areas of the structure section, the force is ultimately conducted via the structure section, so that a further deformation is only possible by deformation of the structure section which is made more solid. In other words, a defined force transmission can be carried out, which initially enables a deformation of the object and then a direct force transmission. The manner of the force transmission or force application can be carried out arbitrarily as tensile, compressive, or bending force or any combinations and can be transmitted by corresponding deformation area and support areas. It is also possible that the object is present without force in the contact state and the structure areas or support areas are detached with deformation of at least one deformation area upon application of force.

As described, the two structure areas or the at least two structure areas can press against one another, in particular in a form-fitting manner, after deformation of the at least one deformation area. A “free path” can be formed in this case, along which the at least one deformation area is deformable upon external force action. The free path specifies, for example, the maximum deformation from the base state up to a contact state in which at least two structure areas press against one another. The “free path” thus designates a relative movement of the at least two structure areas, which can also be referred to as structure elements, with deformation of the at least one deformation area. The structure areas or structure elements are thus formed in the first solidification step, for example as part of the structure section. The at least one deformation area is formed, for example, as part of the deformation section, together with the deformation section in the second solidification step.

The described embodiment allows a deformation of the object to be permitted upon a defined force action on the object. The object can deform here from the base state at least into the contact state. During the deformation in the contact state, the at least two structure areas are led toward one another, wherein the deformation area can deform. If the two structure areas press against one another, the contact state is reached, so that the force is ultimately transmitted via the two structure areas. A further deformation of the object is dependent, from the contact state onward, on the mechanical properties of the structure areas. The described force transmission path can also be implemented as a chain or star chain. The structure areas can be embodied as individual elements or individual structure elements movable in relation to one another, for example, as individual sections of a spring element or as a tongue-and-groove joint, in particular as a dovetail structure. The structure areas are in particular embedded in the at least one deformation area, so that they can be moved relative to one another upon deformation of the deformation area until they press against one another.

The free path can be understood, for example, as the deformation area which forms or is formed between two structure areas. The deformation area ultimately forms a comparatively soft area between two comparatively hard areas, which are formed by the structure areas. In principle, the structure areas can be designed arbitrarily, in particular with respect to their geometry and arrangement. For example, the structure areas and the deformation areas can be arranged alternately, so that one deformation area is arranged between each two structure areas or vice versa. For example, an arrangement of structure areas and deformation areas alternating in the force direction can be implemented. The described arrangement is similar to the structure of a spinal column, in which the structure areas form the spine and the deformation areas form the intervertebral disks. Upon force action on the object, the deformation areas permit a movement until at least two structure areas press against one another. The object can thus be deformed in a defined manner, in particular within the boundaries which specify the at least two structure areas.

In addition to the described design of plate-like or spine-like structure areas, which can be understood, for example, as cylindrical disks, it is also possible to make deformation areas and/or structure areas spherical. For example, the at least one structure area can be embodied as a sphere which is accommodated in a deformation area embodied as a matrix. A reverse arrangement is also possible in that the deformation area is spherical and is enclosed or surrounded by at least one structure area. Specific mechanical properties of the object can be influenced in a targeted manner by the defined arrangement of deformation areas and structure areas. In particular, the impact strength, tendency toward splintering, and defined behavior upon force action can be set in a targeted manner in arbitrary directions, especially three-dimensionally by three-dimensional arrangement of structure areas and deformation areas.

According to a further embodiment of the method, it can be provided that at least one closed, in particular spherical, cuboid, or pyramidal, structure area, which encloses a deformation area, is formed inside the interior. In principle, the shaping of the interior can be selected as desired and can be defined during the formation in the first solidification step. The shapes or geometries can be adapted depending on the mechanical properties which are to be implemented by the formation of the structure section and the deformation section. For example, a comparatively hard sphere can be implemented in a soft matrix, in order to implement defined mechanical properties, but also to reduce splintering in the event of damage. Spherical shells can also be embedded in a deformation area, so that the spherical shells are softly mounted both on the outside and on the inside. This allows the hard component of the object to be selected as smaller and a higher impact strength to be implemented with a high degree of dimensional accuracy. For example, a large number of structure areas, in particular spheres, can be formed as a grid, in particular a grid of spheres, in the interior.

The method can be refined in that at least one cylindrical structure area, in particular a large number of first cylindrical structure areas, is formed which encloses a deformation area. The described design can be understood as a formation of “cylinder systems” or “tunnel systems”, wherein in each case a deformation area is enclosed by a structure area, like a tube. The individual cylindrical structure areas thus enclose, as a hard shell, a soft core in the form of the deformation area. An arbitrary number of first structure areas can in each case in particular be provided here as a first group, which have a specific orientation in space. At least one further group or one further layer of such structure areas, for example, second structure areas, can have a defined second orientation in relation to the first group or first plurality of structure areas. The object or at least one object section is constructed in this case, for example, from at least two layers of structure areas, wherein a first layer has first structure areas having a first orientation and a second layer has second structure areas having a second orientation. The orientations of the layers of the at least two structure areas can enclose, for example, 0°, 45°, 90°, or any other angle.

According to a further design of the method, it can be provided that at least two structure areas are formed spaced apart by at least one deformation area, wherein, upon force action, coupling, in particular form-fitting coupling, of the two structure areas can be produced. According to this design, in particular a plug-in system can be implemented. The object in this case allows latching to be possible once due to force action, which provides a latching resistance which cannot be reset back into the base state, at least independently. In other words, the at least two structure areas form a latching mechanism, so that upon force action which causes a deformation of the deformation area, the at least two structure areas can be engaged with one another in a form-fitting manner, for example, like a latch, snap, or click connection.

In addition to the method, the disclosure relates to an additively manufactured three-dimensional object, which is manufactured from a resin-based construction material that is liquid in a base state and can be solidified, wherein in a first solidification step at least one structure section having a first degree of solidification is formed, which delimits at least one interior accommodating liquid construction material and in a second solidification step a deformation section having a second degree of solidification different from the first degree of solidification is formed from the liquid construction material accommodated in the interior. In other words, the object is manufactured according to the above-described method.

The disclosure furthermore relates to a device for additive manufacturing of three-dimensional objects, which device is designed to carry out the above-described method. The device in particular has the units configured for carrying out the at least two solidification steps, for example, at least one solidification unit which is designed to carry out the first solidification step, for example, by selective solidification of the construction material and to carry out the second solidification step, for example, by temperature control of the liquid construction material within the interior. The device especially has a first solidification unit which is designed for selective solidification of the construction material by means of radiation to form the structure section and at least one second solidification unit which is designed for temperature control of the object to solidify the liquid construction material to form the deformation section.

All advantages, details, embodiments, and/or features which have been described with respect to the method are transferable completely to the device and the object.

The disclosure is explained below on the basis of exemplary embodiments with reference to the figures. In the figures, which are schematic representations, in which:

### BRIEF DESCRIPTION OF THE DRAWINGS

FIG. 1 shows a schematic diagram of an additively manufactured object;

FIG. 2 shows a schematic diagram of an additively manufactured object;

FIG. 3 shows a schematic diagram of an additively manufactured object;

FIG. 4 shows a schematic diagram of an additively manufactured object;

FIG. 5 shows a schematic diagram of an additively manufactured object;

FIG. 6 shows a schematic diagram of an additively manufactured object; and

FIG. 7 shows a schematic diagram of an additively manufactured object.

### DETAILED DESCRIPTION OF THE DRAWINGS

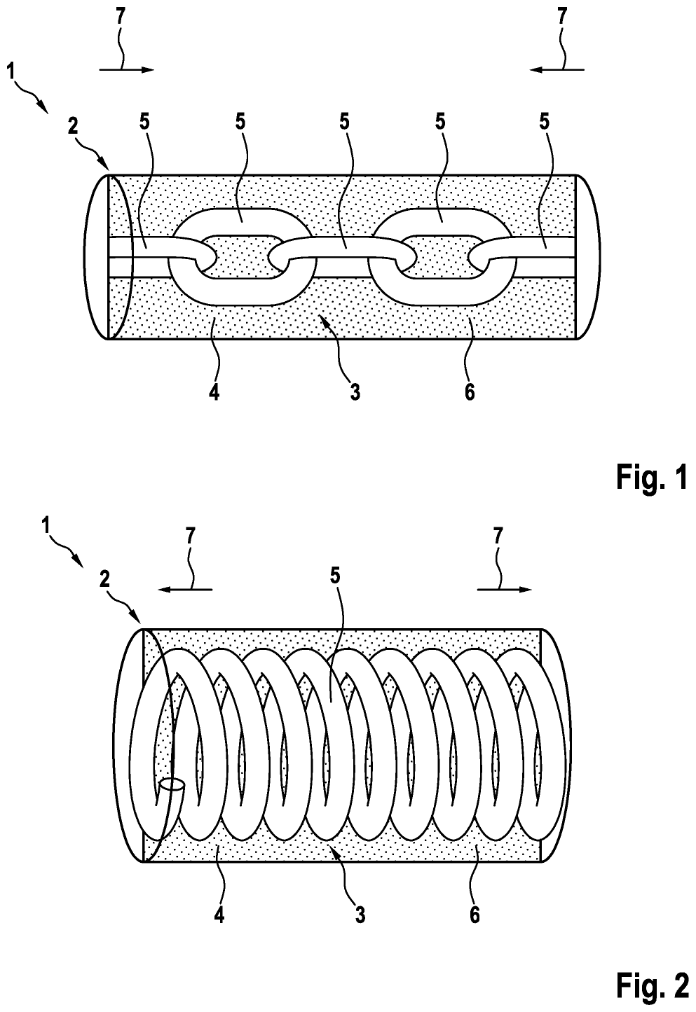

FIG. 1 shows a three-dimensional object 1, which is manufactured in an additive manufacturing process from a resin-based construction material. The object 1 has a structure section 2 and a deformation section 3. The object 1 can have any further structure sections 2 and deformation sections 3 or the object 1 shown can be understood as a detail of a larger object 1 having arbitrary further areas and components. The structure section 2 delimits an interior 4.

In a method for manufacturing the object 1, a first solidification step is carried out in which the structure section 2 is formed. For example, the first solidification step can be carried out by selective exposure of the construction material, wherein the construction material solidifies to a first degree of solidification and forms the structure section 2. In the interior 4, which is delimited by the structure section 2, non-solidified liquid construction material remains enclosed or spatially delimited. After the first solidification step, a second solidification step can be carried out in which the liquid construction material enclosed in the interior 4 is solidified to form the deformation section 3. As described, the structure section 2 has a first degree of solidification and the deformation section 3 has a second degree of solidification. The two degrees of solidification are different, in particular the structure section 2 is made more solid or harder than the deformation section 3, which is made softer or more elastic and deformable than the structure section 2.

It can ultimately be defined by the selective solidification in the first solidification step which sections of the object 1 are to be formed as the structure section 2 and in which areas an interior 4 is formed, in which liquid construction material can be formed as the deformation section 3 in the second solidification step. The mechanical properties of the object 1 may thus ultimately be set arbitrarily, so that a deformation of the object 1 under external force action is possible in a targeted manner by a deformation of the at least one deformation section 3, which can accordingly be delimited via the formation of the at least one structure section 2. The object 1 is in particular formed from a uniform material, so that different construction materials do not have to be used, rather only precisely one construction material is used.

FIGS. 1-7 show different exemplary embodiments which are different with respect to the arrangement, formation, and distribution of the respective components of the structure section 2 or the deformation section 3. The figures ultimately show embodiments or options for how the force action on the object 1 can be conducted and corresponding forces can be transmitted by means of the structure sections 2 and deformation section 3 or how the object 1 can behave under force action. Arbitrary combinations of the mechanisms shown in the individual figures are possible in this case.

As described, the object 1 in FIG. 1 has a structure section 2, which delimits an interior 4, in which the deformation section 3 is at least partially arranged. The structure section 2 has multiple structure areas 5, which become formed or are formed together with the structure section 2 in the first solidification step. Solely by way of example, the structure areas 5 are shown in this exemplary embodiment as chain links, which accordingly enable a force transmission. The structure areas 5 are embedded here in the deformation section 3 or a deformation area 6 of the deformation section 3. Depending on which force acts externally on the object 1, the object 1 is deformable so that the structure areas 5 can move relative to one another and can thus permit a defined movement or deformation of the object 1.

For example, the object 1 can be pressed together or compressed in the situation shown in FIG. 1, as schematically shown by arrows 7. The representation in FIG. 1 can also be understood as a contact state in which the structure areas 5 press against one another. If a force is produced on the object 1, for example against the arrow direction shown, the tensile force is transmitted between the two ends of the object 1 directly via the structure areas 5. In a direction opposite to the direction shown by the arrow direction, a deformation of the object 1 is possible with relative movement of the structure areas 5. The deformation area 6 allows a deformation of the object 1 in this case. The chain shown can also be understood as a force transmission path, along which forces can be transmitted according to the arrangement of the structure areas 5 and deformation areas 6. In principle, the object 1 can comprise any force transmission path, for example, in the form of a star chain.

FIG. 2 shows an object 1 according to a second exemplary embodiment. A structure area 5, which is formed as a helical spring, is arranged inside the interior 4 in the second exemplary embodiment. The structure area 5, as described, is embedded inside the interior 4 in a deformation area 6. It is also possible in the second exemplary embodiment, as described with reference to the first exemplary embodiment, that a force is produced on the object 1 along the arrow directions, which are shown by the arrows 7. In this exemplary embodiment, the base state is shown in FIG. 2. If the object 1 is deformed, a deformation of the object 1 is permitted to a limited extent by the structure area 5. A contact state is achieved at the latest when multiple turns of the structure area 5 press against one another, in which a further deformation of the object 1 is only possible to a limited extent or is no longer possible at all.

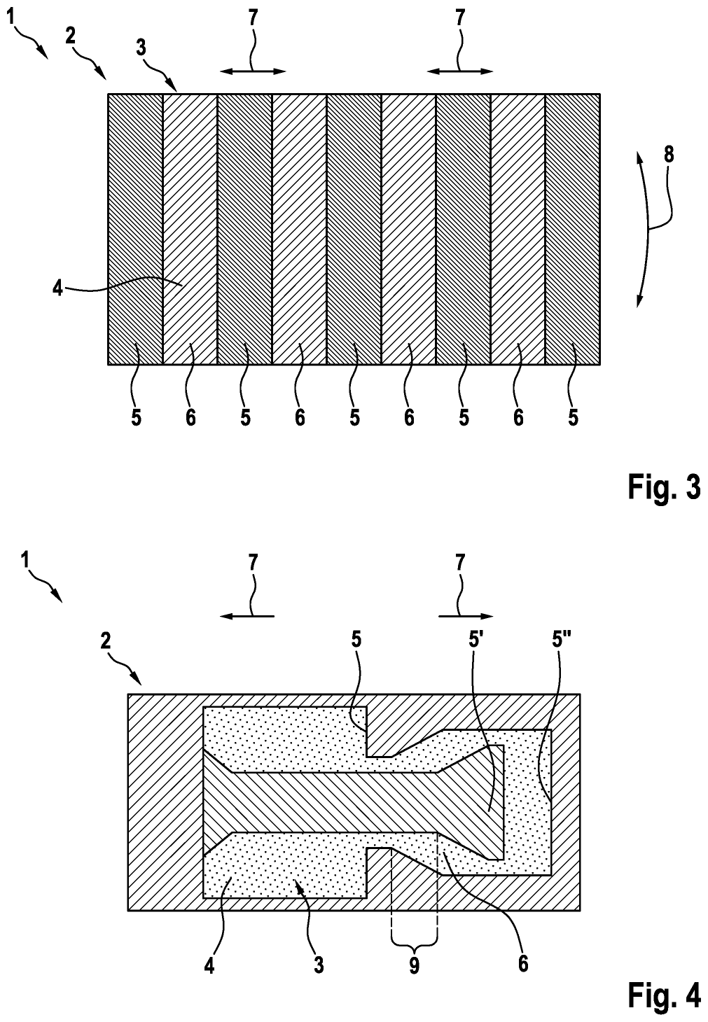

FIG. 3 shows a detail of an object 1, in which the structure section 2 has multiple structure areas 5 and the deformation section 3 has multiple deformation areas 6, which are arranged alternating in an object direction of the object 1, for example, a longitudinal direction. The object 1 according to the third exemplary embodiment is constructed like a spinal column, wherein the structure areas 5 represent the spine and the deformation areas 6 represent the intervertebral disks.

In the design according to FIG. 3, a deformation of the object 1 is thus possible according to arrows 7, in that the deformation area 6 is compressed or stretched or lengthened. Bending or general deformation of the object 1 is also possible, as shown by way of example by arrow 8. The structure areas 5 limit the movement of the object 1. A further movement, for example, a further compression or bend, is not readily possible at the latest in a contact state, in which two structure areas 5 press against one another.

FIG. 4 shows an object 1 according to a fourth exemplary embodiment. In the representation shown, a base state is assumed in which a first structure area 5 and a second structure area 5′ are provided spaced apart from one another. In particular, a free path length or free path 9 is shown, which can be covered or by which the structure areas 5, 5′ can be moved toward one another before the first structure area 5 presses against the second structure area 5′. After the free path 9, i.e., when the object 1 is stretched accordingly, the structure areas 5, 5′ press against one another so that a contact state is implemented. The structure areas 5, 5′ form a form fit in this exemplary embodiment here, which prevents further movement or further stretching of the object 1. The structure area 5′ can also be brought into contact with a further third structure area 5″, when the object 1 is pressed together or compressed from the base state shown in FIG. 4, in particular against the arrow direction of the arrows 7. If the structure area 5′ presses against the third structure area 5″, further compression of the object 1 is no longer possible or is only still possible to a very limited extent.

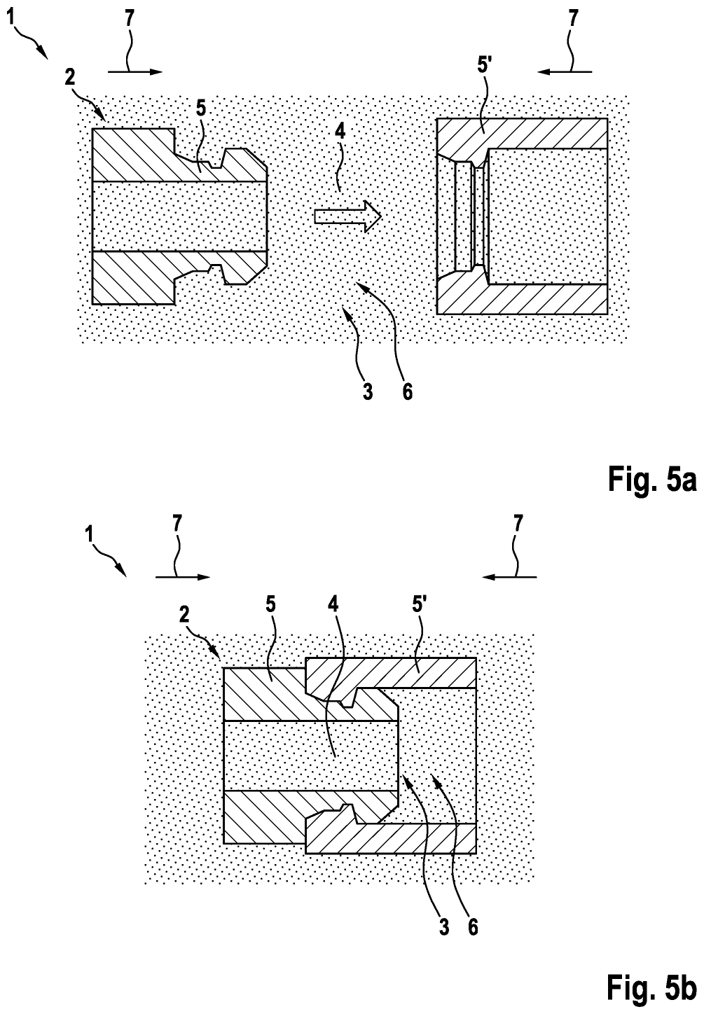

FIGS. 5a, 5b show a detail of an object 1 according to a fifth exemplary embodiment. In this case, FIG. 5a shows a base state and FIG. 5b shows a coupled state or coupling state of the object 1. The object 1 has two structure areas 5, 5′, which are spaced apart from one another in the base state by the deformation section 6. In other words, the structure areas 5, 5′ are loosely coupled to one another by the deformation section 6, so that they can be moved toward one another with deformation of the deformation section 6.

In this case, the object 1 can be deformed such that a form fit can be established between the two structure areas 5, 5′, so that they are fixedly coupled with one another. After establishing the form fit, the structure areas 5, 5′ remain coupled to one another, so that they no longer detach from one another independently. For example, the structure areas 5, 5′ can be transferred once from the base state shown in FIG. 5a into the coupled state shown in FIG. 5b in that, for example, a snap, catch, or clip connection is implemented. It can also be provided that a release of the form-fitting coupling, for example by increased application of force, is possible again from the state shown in FIG. 5b.

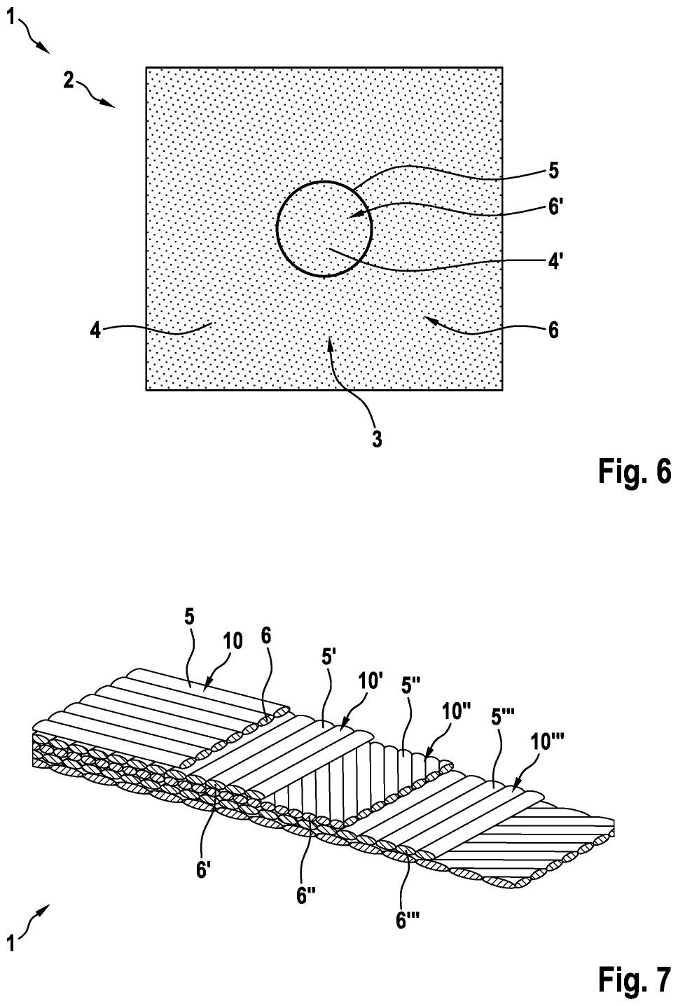

FIG. 6 shows an object 1 according to a sixth exemplary embodiment. The object 1 has a structure section 2, which defines or delimits an interior 4, in which construction material is solidified to form a deformation section 3. A structure area 5 of the structure section 2, which is formed in the shape of a sphere, is arranged inside the deformation section 3 or a deformation area 6. In the exemplary embodiment shown, the structure area 5 delimits a further interior 4′, in which a further deformation area 6′ is arranged. In principle, it would also be possible that the structure area 5 is embodied completely as a structure section 2, which means that it is manufactured completely in the first solidification step and therefore no deformation area 6′ is located in the interior.

The design according to FIG. 6 in particular enables a deformation of the object 1 around the structure area 5. The dimensional accuracy can be ensured by the structure area 5, wherein both the hard proportion of the object 1 can be reduced and also a tendency toward splintering in the event of damage can be reduced. The shape of the structure area 5 can be selected as desired. In particular, departing from a spherical shape, a cuboid, a pyramid, a cylinder, and any other three-dimensional shape can also be used. In principle, the interior 4 can be filled arbitrarily with structure areas 5, for example, in fundamentally known spatial arrangements or packing.

FIG. 7 shows an object 1 according to a seventh exemplary embodiment. The structure section 2 of the object 1 has a large number of different structure areas 5, which are arranged in multiple layers 10. In principle, the individual structure areas 5 can be understood as cylinders or tubes, which each delimit an interior 4 in which a deformation area 6 is formed. In other words, the object 1 is manufactured in that in a first solidification step the large number of the structure areas 5 are solidified, wherein liquid construction material is accommodated and delimited in the interior 4. In the second solidification step, the liquid construction material in the individual interiors 4 of the structure areas 5 is solidified, so that the deformation areas 6 form in the interior of the structure areas 5.

Solely by way of example, it is shown that the orientation of the structure areas 5 changes in the individual layers 10. For example, first structure areas 5 in a first layer 10 are aligned in a first orientation, for example, 0° in relation to a longitudinal axis of the object 1. For example, in a second layer 10′, the structure areas 5′ are aligned in a second orientation, for example, 90° in relation to the longitudinal axis of the object 1. In a further example, in a third layer 10″, the structure areas 5″ are aligned in a third orientation, for example, 45° in relation to the longitudinal axis of the object 1. In a further fourth layer 10′″, the structure areas 5′″ can be aligned in a fourth orientation in relation to the longitudinal axis of the object 1, for example, again aligned by 90° in relation to the longitudinal axis of the object 1, as in the second layer 10′. The orientation can be repeated. It is also possible to provide arbitrary other angles, orientations and the like. The cross-sectional shape of the structure areas 5 can be selected to be circular, oval, cuboid, triangular, polygonal, or anything else. The number of the structure areas 5, as well as their diameter, number of the layers, and arrangement, can also be adapted to the specific application of the object 1.

As described at the outset, all advantages, details, and features which are described in the individual embodiments can be completely exchanged with one another, combined with one another, and transferred to one another. The objects 1 which are shown in FIGS. 1-7 are manufactured in a method for additive manufacturing. In a first solidification step, the structure section 2 having the structure areas 5 is manufactured and in a second solidification step, the deformation section 3 having the deformation areas 6 is manufactured. For example, the first solidification step is carried out by selective exposure and accompanying solidification of the liquid construction material, wherein liquid construction material remains in the interiors 4 delimited by the structure areas 5. The liquid construction material is then solidified in a second solidification step, in particular by temperature control of the object 1. The structure areas 5 and the deformation areas 6 have different degrees of solidification.

The method can be carried out in particular on a device (not shown in more detail), which is designed for additive manufacturing of three-dimensional objects. The device has a solidification unit, which is designed to carry out the two solidification steps, or the device has two different solidification units for separately carrying out the two solidification steps. The first solidification step can be carried out in an additive manufacturing process which is carried out on the device. The second solidification step can be carried out inside the construction space of the device 1 or can be carried out in a separate unit of the device after the object 1 is removed from the construction space. The device can thus be understood as a system which has at least one additive manufacturing device and at least one second solidification unit, in particular a heating unit, which can be formed as desired externally or internally in relation to the additive manufacturing device. For example, after completing the additive manufacturing process, the object 1 can be moved into a furnace in which the second solidification step is carried out to form the deformation areas 6. Alternatively, a construction chamber or a postprocessing unit of an additive manufacturing device can be used to solidify the deformation section.

### LIST OF REFERENCE

1 object
2 structure section
3 deformation section
4 interior
5 structure area
6 deformation area
7,8 arrow
9 path
10 layer

1.-11. (canceled)

12. A method for additive manufacturing of an item, the method comprising:
a first solidification step in which at least one structure section having a first degree of solidification is formed, and which delimits at least one interior accommodating a liquid construction material, wherein the item is a three-dimensional object having a resin-based construction material which is liquid in a base state and is solidifiable; and
a second solidification step forming a deformation section having a second degree of solidification that is different from the first degree of solidification, the deformation section being formed from the liquid construction material accommodated in the interior.

13. The method according to claim 12, wherein the first solidification step is carried out by exposing construction material and/or the second solidification step is carried out by temperature control of construction material.

14. The method according to claim 12 further comprising a step of forming at least two areas of the object to define mechanical properties of the object, and/or a structure defining the mechanism that is divided into the first solidification step and the second solidification step.

15. The method according to claim 12, wherein the formation of at least one force transmission path arranged in the interior, which force transmission path has a defined deformation area and a defined support area, and/or a structure area having the first degree of solidification within a deformation area having the second degree of solidification.

16. The method according to claim 15, further comprising: a deformation area that is formed, in which, upon force action on the object, a free path line, along which the deformation area is deformable, and is coverable from a base state up to a contact state, in which at least two structure areas press against one another.

17. The method according to claim 15, wherein the free path line is formed as a deformation area between two structure areas.

18. The method according to claim 15, further comprising: at least one closed, spherical, cuboid, or pyramidal, structure area, which encloses a deformation area, and that is formed inside the interior.

19. The method according to claim 15, further comprising: at least one cylindrical structure area that are formed, and which enclose a deformation area.

20. The method according to claim 15, further comprising: at least two structure areas that are formed spaced apart by at least one deformation area, wherein form-fitting coupling, of the two structure areas is established upon force action.

21. A device for additive manufacturing of three-dimensional objects which is designed to carry out the method according to claim 12.

22. An apparatus comprising:
an additively manufactured three-dimensional object, having a structure formed by a resin-based construction material that is liquid in a base state and is solidifiable, wherein the additively manufactured three-dimensional object has at least one structure section with a first degree of solidification structure, and which delimits at least one interior accommodating liquid construction material, and having a second solidification deformation section having second degree of solidification structure that is different from the first degree of solidification structure and is formed from the liquid construction material accommodated in the interior.
